(19) United States
(12) Patent Application Publication
(10) Pub. No.: US 2005/0051115 A1
(43) Pub. Date: Mar. 10, 2005

(54) Engine with rotatable cylinder head assembly

(76) Inventors: Urs Wenger, Rumisberg (CH); Hans-Rudolf Jenni, Grasswil (CH); Christian Weber, Markdorf (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/888,799

(22) Filed: Jul. 9, 2004

Related U.S. Application Data
(60) Provisional application No. 60/486,020, filed on Jul. 9, 2003.

(51) Int. Cl. F02B 75/20

(52) U.S. Cl. 123/41.74; 123/58.1; 123/DIG. 1

(57) ABSTRACT

An engine having an engine block and a cylinder head assembly. The cylinder head assembly includes an air inlet and an air outlet for each cylinder of the engine. The engine is operable with the cylinder head assembly connected to the engine block in either of first or second positions, where the second position is rotated from the first position.

### RELATED APPLICATION

This application claims priority to provisional U.S. Application Ser. No. 60/486,020, filed Jul. 9, 2003.

### FIELD OF THE INVENTION

The following invention relates to engines, and in particular, to engines having adaptable configurations.

### BACKGROUND OF THE INVENTION

Generally, an internal combustion engine will include an engine block and a cylinder head assembly that is rigidly attached to the engine block. The cylinder head assembly typically includes a valve cover and a cylinder head covering one or more cylinders. The cylinder head includes an intake side for both air and fuel and an outlet side for exhaust. The intake and outlet are typically located on opposing sides of the cylinder head.

When an engine compartment is designed for a vehicle using an internal combustion engine, the compartment is generally configured such that output from the engine is in a particular direction, for example, rearward. By configuring the output to be in a particular direction, the engine orientation and placement (in relation to the vehicle chassis) are subsequently quite limited since the cylinder head assembly (and thus, the air and fuel intake side and the exhaust outlet side) is only attached to the engine block in one position. In addition, the positioning of the cylinder head assembly inside the engine compartment is further dictated by positioning the engine's timing assembly, which is typically located along one side of the engine block.

With this lack of adjustability in regard to the engine, the desired directional output of the engine largely dictates how the engine block is mounted to the vehicle chassis, such that the intake and the outlet can be provided on correspondingly appropriate sides of the engine. As such, there is little flexibility for other engine applications. For example, modern manufacturers tend to try and use the same engines in multiple applications. One or more of these other applications may call for the intake and exhaust to be oriented differently than what is described above. Unfortunately, these applications could not be easily provided for with current internal combustion engines. As such, there would likely be increased costs in going forth on these applications, and in turn, there would likely be less appeal for designing vehicles adopting these alternative engine compartment designs not only because of these increased costs, but also because of the general lack of design flexibility regarding the engine.

### BRIEF SUMMARY OF THE INVENTION

According to some embodiments of the invention, there is provided an engine with an engine block and a cylinder head assembly. The cylinder head assembly includes an air inlet and an air outlet for each cylinder of the engine. The engine is operable with the cylinder head assembly connected to the engine block in either of first or second positions, where the second position is rotated from the first position.

In some embodiments the engine has two cylinders. In other embodiments, the engine has one or more cylinders.

### BRIEF DESCRIPTION OF THE DRAWINGS

FIG. 1 is a schematic, side perspective view of an engine block and cylinder head assembly in accordance with certain embodiments of the invention;

FIG. 2 is a schematic, side perspective view of the engine block and cylinder head assembly of FIG. 1, in which the cylinder head assembly has been rotated about 180 degrees relative to the engine block;

FIG. 3 is a schematic, cutaway elevation view of the engine block and cylinder head assembly of FIG. 1 in accordance with certain embodiments of the invention;

FIG. 4 is a bottom view of the cylinder head assembly of FIG. 1; and

FIG. 5 is a top view of the engine block of FIG. 1.

### DETAILED DESCRIPTION OF THE INVENTION

The following detailed description is to be read with reference to the drawings, in which like elements in different figures have like reference numerals. The drawings, which are not necessarily to scale, depict selected embodiments, but are not intended to limit the scope of the invention. It will be understood that many of the specific details of an engine incorporating the invention illustrated in the drawings could be changed or modified by one of ordinary skill in the art without departing significantly from the spirit of the invention. The engine of the invention is designed for use on vehicles such as personal watercraft, snowmobiles, all-terrain vehicles, motorcycles, and the like; however, it may also be used on any other vehicle using an engine that includes an engine block with attached cylinder head assembly.

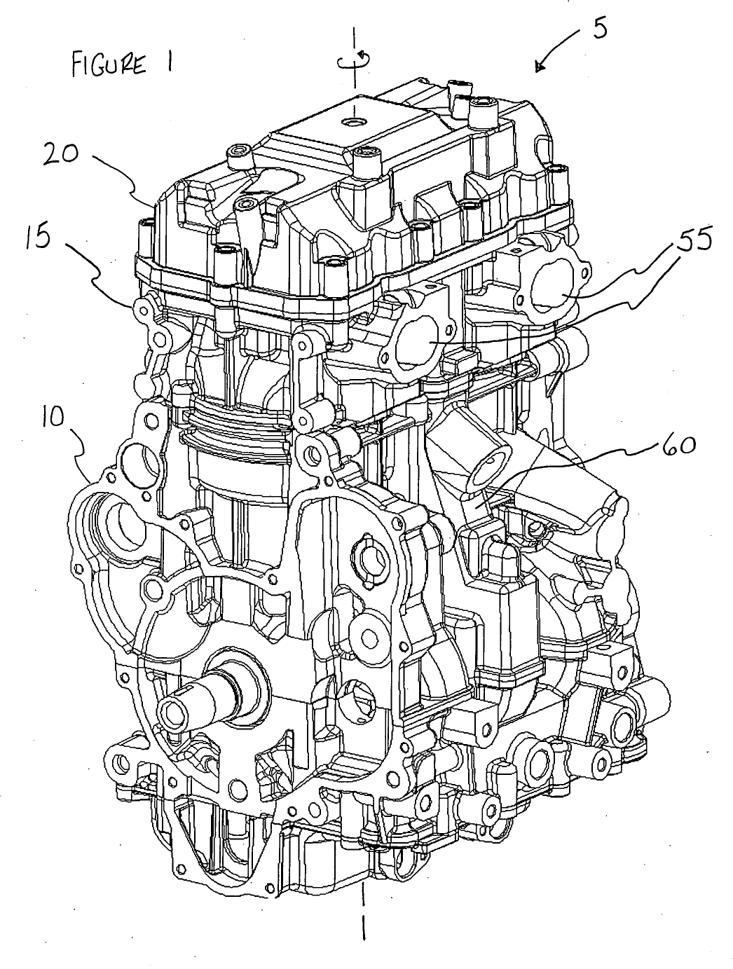

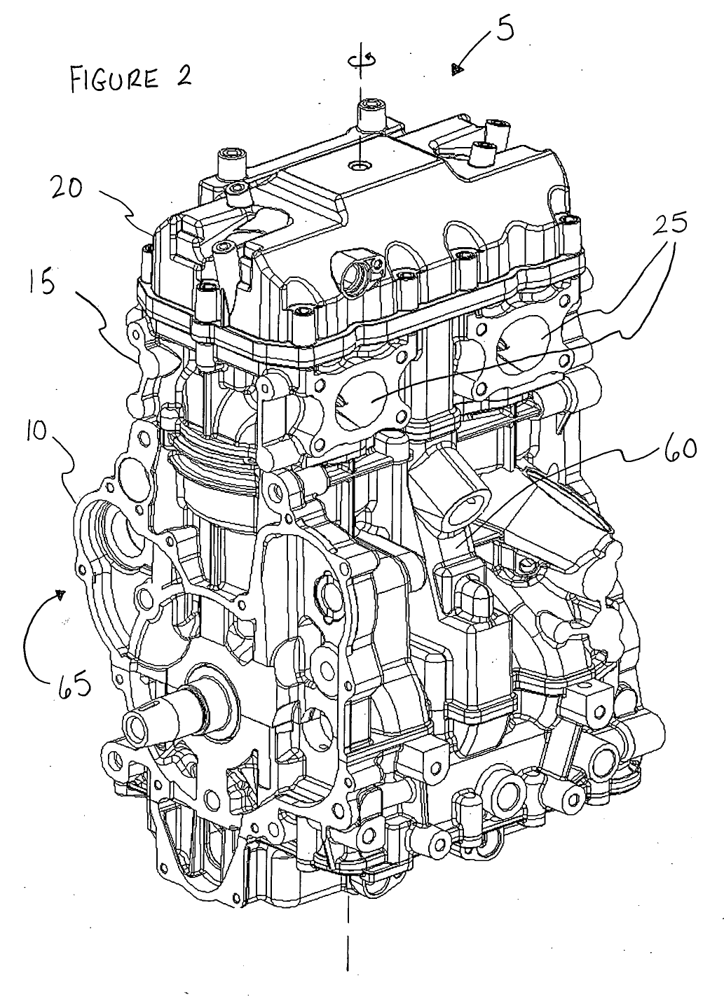

In certain preferable embodiments of the invention, an engine having an engine block and a cylinder head assembly is provided in which the cylinder head assembly can be attached to the engine block in two different positions. The cylinder head assembly includes a valve cover and cylinder head covering one or more cylinders. The cylinder head assembly may be mounted to the engine block in a first position (shown in FIG. 1), or a second position (shown in FIG. 2) in which the cylinder head assembly is preferably rotated about 180 degrees relative to the engine block before it is mounted to the engine block. In order to achieve this adaptability, a timing mechanism (i.e., timing gear) is preferably located towards the middle of the engine, rather than at one of its ends. In addition, a hole pattern on the cylinder head assembly is preferably made substantially symmetrical with a bore pattern on the engine block in order to enable the cylinder head assembly to be connected to the engine block in either position. Furthermore, a coolant flow channel is preferably provided to facilitate proper coolant flow to both the intake and outlet sides of the cylinder head assembly independent of the cylinder head assembly position.

FIG. 1 illustrates a side perspective view of an internal combustion engine 5. The engine 5 includes an engine block 10 and a cylinder head assembly. In certain embodiments, the cylinder head assembly includes a valve cover 20 and a cylinder head 15 covering one or more cylinders. In this configuration, the engine 5 has air inlets 55 located on a first side 60. In contrast, FIG. 2 shows a side perspective view of the engine 5 of FIG. 1, but with the cylinder head assembly rotated about 180 degrees from the position shown in FIG. 1. Consequentially, with the rotated configuration of FIG. 2, exhaust outlets 25 are now located on the first side 60, while the air inlets 55 (not visible in FIG. 2) are located on a second side 65, opposite the first side 60. In preferable embodiments, the engine is an internal combustion engine, however, it is contemplated that other embodiments may exist in which other engines containing engine blocks or the like and cylinder assemblies or the like can be utilized. Further, it is appreciated that the engine described above, as well as other engines, may further be made adjustable so that the exhaust outlets on the cylinder head assembly can be initially positioned or repositioned to any desired side of the engine regardless of the type of engine or its particular engine block/cylinder head assembly configuration, in adhering to the teachings herein.

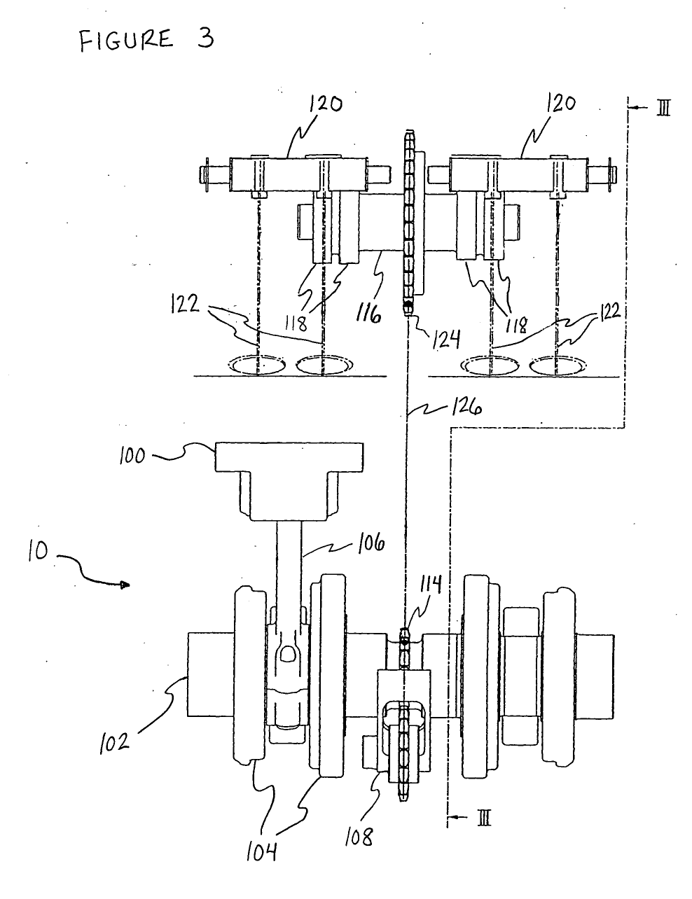

FIG. 3 illustrates a cutaway elevation view of the engine block 10 and the cylinder head assembly of FIG. 1 for a stroke piston engine design, only showing certain interior parts. As shown, the engine block 10 comprises one or more parallel standing pistons 100 (only one of which is shown), each of which runs up and down a corresponding cylinder (not shown). A crankshaft 102 is located under the one or more pistons 100, and is connected to a pair of crank pins 104, each of which supports a connecting rod 106. Each connecting rod 106 is, in turn, connected to one of the pistons 100, and functions in moving the piston 100 through its cycle.

As further shown in FIG. 3, a camshaft 116 is positioned above the pistons 100 in the cylinder head assembly. Cams 118 of the camshaft 116 are actuated with the rotation of the camshaft 116 in order to move rocker arms 120 which cooperate with respective valves alongside a valve axis 122. The camshaft 116 is driven via a camshaft chain gear 124 which is located between the cams 118. In the example, this camshaft chain gear 124 is located in the center of the camshaft 116. For other engine versions, as described earlier, it may be located off-center. The camshaft 116 is driven by the crankshaft 102 via a timing chain 126 being drawn between the camshaft chain gear 124 and a crankshaft chain gear 114. A further possible version of the camshaft drive includes a design with toothed belt and toothed-belt wheels instead of chain and chain gears.

While FIG. 3 illustrates the cutaway elevation view of both the engine block 10 and the cylinder head assembly of FIG. 1, showing certain interior parts, a modification must be performed with regard to the camshaft 116 and camshaft chain gear 124 after the cylinder head assembly is rotated as in FIG. 2. The modification involves an axial adjustment of the camshaft chain gear 124 in relation to the timing chain 126. This adjustment generally involves shifting the gear 124 forward or backward to a certain degree so that the rocker arms 120 in the intake and the outlet sides of the cylinder head assembly can move the corresponding valves in appropriate rhythm with the movement of the pistons 100. A detailed discussion explaining the reasoning behind this modification is not provided herein as it would be obvious to those skilled in the art. However, generally speaking, without adjusting the camshaft chain gear 124 in the cylinder head assembly, the rocker arms 120 that move the intake and outlet valves would not be in tune with the cycling of the pistons 100, likely resulting in the engine operating inefficiently, if at all.

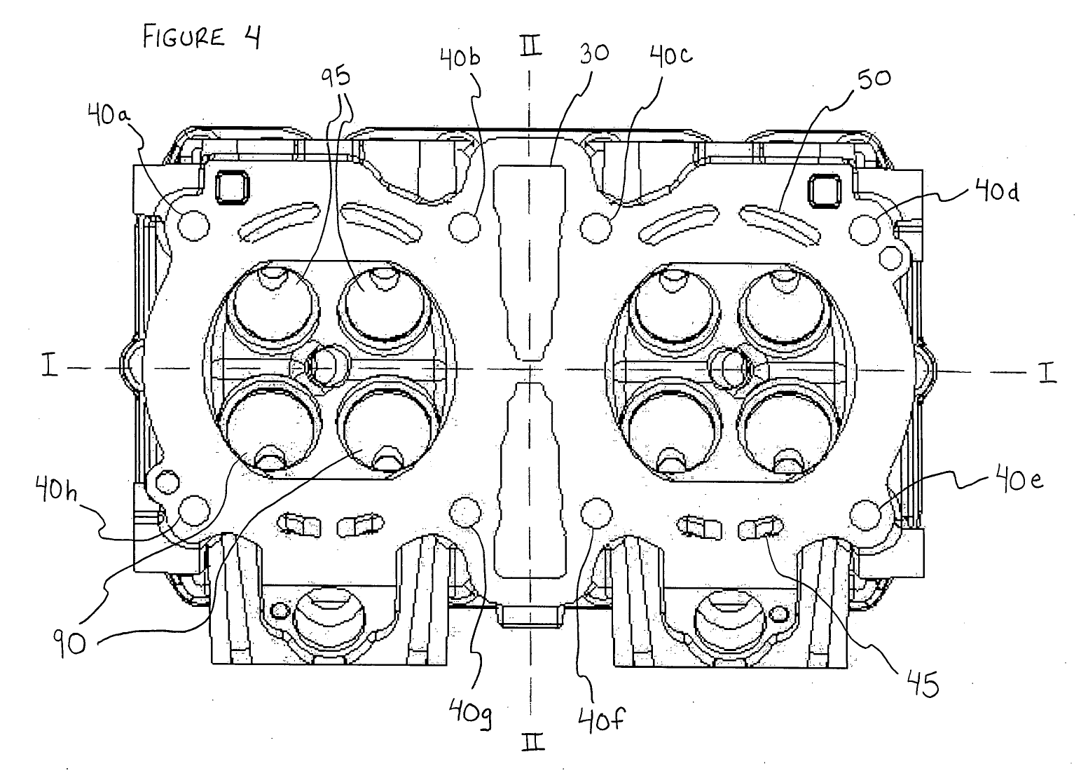

FIG. 4 shows a bottom surface of the cylinder head assembly. A chaining pit 30 is provided towards the middle of the cylinder head assembly. The chaining pit 30 is substantially symmetrical relative to planes I-I and II-II, as shown in FIG. 4. A timing mechanism such as a chain (referenced as 126 in FIG. 3), belt, or equivalent thereof passes through the chaining pit 30. Additionally, holes 40a through 40h are defined in the cylinder head assembly. The holes 40a through 40h form a pattern on the bottom surface of the cylinder head assembly, and are each designed to receive a portion of a fastener used in mounting the cylinder head assembly to the engine block 10. The holes 40a through 40h are substantially symmetrical relative to planes I-I and II-II.

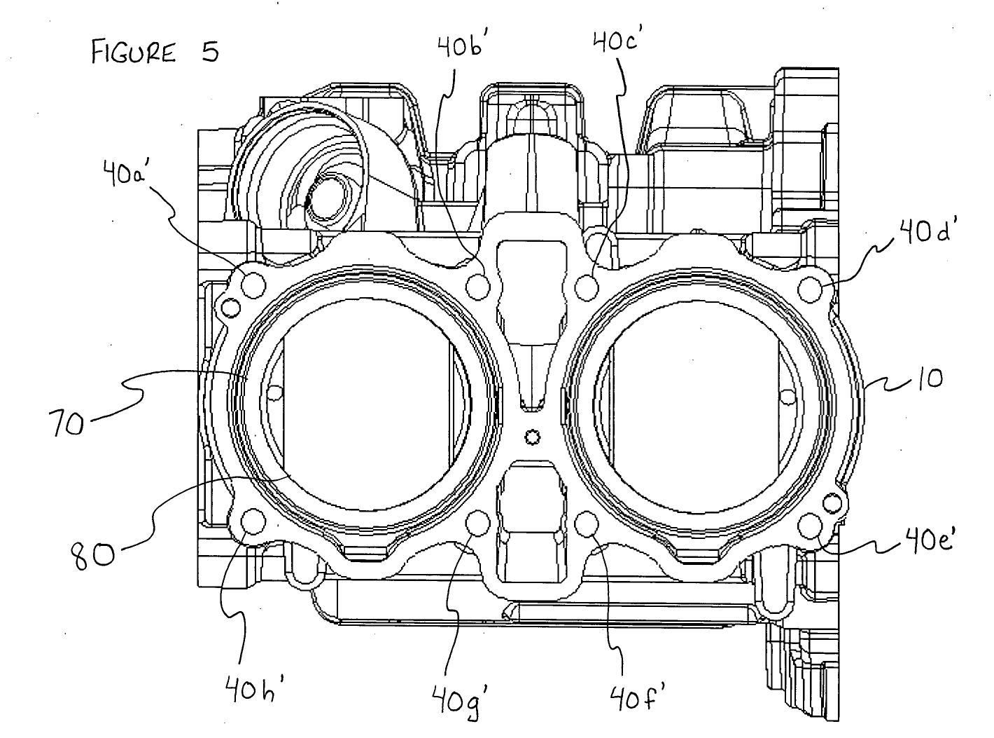

FIG. 5 illustrates a top surface of the engine block 10, in which bores 40a′ through 40h′ are defined. The bores 40a′ through 40h′ form a pattern that is substantially similar to the pattern found on the bottom surface of the cylinder head assembly, involving holes 40a through 40h. As such, when the cylinder head assembly is attached to the engine block 10, a plurality of fasteners will be used to extend through holes 40a through 40h and respectively into bores 40a′ through 40h′. Referring back to FIG. 4, the intake of the cylinder head assembly communicates with a cylinder 80 of the engine block 10 by a plurality of intake holes 90, each normally filled with a valve. The outlet of the cylinder head assembly communicates with the cylinder 80 of the engine block 10 by a plurality of exhaust outlet holes 95, each normally filled with a valve.

Furthermore, the invention provides for a plurality of intake cooling channels 45 and exhaust cooling channels 50 that allow coolant to flow when the cylinder head assembly is attached to the engine block 10 as shown in FIG. 1 or FIG. 2. Intake cooling channels 45 and exhaust cooling channels 50 are sized to meet the cooling requirements of each side of the engine and may be the same or different sizes. As depicted in FIG. 5, an open coolant flow channel 70 makes coolant (not shown) available for entry into both the intake cooling channels 45 and the exhaust cooling channels 50. The coolant flow channel 70 must be large enough so that coolant flow is not restricted from entering into either of the intake cooling channels 45 or the exhaust cooling channels 50 when the cylinder head assembly is in either position.

The substantial symmetry of the chaining pit 30 and the cylinder head assembly/engine block screw connections, coupled with the intake cooling channels 45, exhaust cooling channels 50, and coolant flow channel 70 allows for the cylinder head assembly to be attached to the engine block 10 in the configuration shown in FIG. 1 or in the configuration shown in FIG. 2. Rotating the cylinder head assembly by about 180 degrees relative to the engine block 10 allows either the exhaust outlets 25 or the air inlets 55 to be on the first side 60 of the internal combustion engine 5.

In certain preferable embodiments of the invention, the configuration of an existing engine may be modified or adjusted by rotating the cylinder head assembly relative to the engine block. Initially, the intake and outlet sides of the engine would be determined in accordance with a particular application's requirements. However, the cylinder head assembly could then be rotated relative to the engine block (generally attached to a chassis) to provide the intake and outlet sides in contrast to the earlier determination.

Given its adjustability, the engine of the present invention is more adaptable to specific applications than prior engines. The flexibility of being able to specify which side of the engine is the intake side and which is the outlet side after the outlet direction is fixed allows for the same engine to be used in a greater number of applications relative to nonadjustable engines. In addition, this adjustability will lower the cost of developing new applications. Further, the adjustability enables the engine to be adapted to a particular application later in the production timeline than previous engines would have allowed. Finally, vendors designing new vehicles for their engines will have a greater freedom in their design because they will not be constrained by an intake side or outlet side fixed by the direction of the engine output. This flexibility will increase the variety of new vehicle designs.

While a preferred embodiment of the present invention has been described, it should be understood that various changes, adaptations, and modifications may be made therein without departing from the spirit of the invention and the scope of the appended claims.

1. An engine comprising:
an engine block defining two adjacent cylinders, each cylinder having a central axis;
two pistons, each piston being axially reciprocable in a respective cylinder; and
a cylinder head assembly having an air inlet for each cylinder and an air outlet for each cylinder, the inlets and outlets being positioned on opposite sides of the cylinder head assembly, the cylinder head assembly connectable to a surface of the engine block in a first position and a second position, the engine being operable with the cylinder head assembly connected in either of the first or second positions, the second position being rotated from the first position.

2. The engine of claim 1, wherein the engine block defines a pattern of connection bores and the cylinder head assembly defines a pattern of connection bores through which connectors may fasten the cylinder head assembly to the engine block, the patterns of connection bores being aligned when the cylinder head assembly is in either the first or second positions.

3. The engine of claim 1, further including a timing mechanism extending from the cylinder head through the engine block to a crankshaft, the timing mechanism extending centrally between the cylinders.

4. The engine of claim 3, wherein the timing mechanism is a chain timing mechanism.

5. The engine of claim 4, wherein the chain timing mechanism includes a chain positioned between the cylinders.

6. The engine of claim 4, wherein the timing mechanism includes a camshaft chain gear positioned between the cylinders.

7. The engine of claim 4, wherein the timing mechanism includes a crankshaft chain gear positioned between the cylinders.

8. The engine of claim 4, wherein the cylinder head includes a chain pit positioned symmetrically about a plane extending centrally between the cylinders.

9. The engine of claim 4, wherein the cylinder head includes a chain pit positioned symmetrically about a plane extending centrally through both cylinders.

10. The engine of claim 3, wherein the second position of the cylinder head assembly is rotated generally 180 degrees about the connecting surface of the engine block from the first position of the cylinder head assembly.

11. The engine of claim 1, wherein the cylinders have cooling jackets, the engine block connecting surface defining open coolant flow channels leading to the cooling jackets, a bottom surface of the cylinder head assembly defining for each cylinder an intake cooling channel through which coolant may flow to cool the respective air inlets and an exhaust cooling channel through which coolant may flow to cool the respective air outlets, the open coolant flow channels, and intake and exhaust cooling channels being positioned to allow coolant flow between the cylinder head assembly and the engine block when the cylinder head assembly is in either the first or second positions.

12. An engine comprising:
an engine block defining one or more cylinders, each cylinder having a central axis;
one or more pistons each axially reciprocable in respective cylinders; and
a cylinder head assembly having a first side defining one or more air inlets and a second side defining one or more exhaust outlets, the cylinder head assembly connectable to a surface of the engine block in a first position to enable fluid communication from each air inlet to a respective cylinder and a respective exhaust outlet, the cylinder head assembly connectable to the top surface of the engine block in a second position so as to enable fluid communication from each air inlet to a respective cylinder and a respective exhaust outlet, the engine being operable with the cylinder head assembly in either of the first or second positions, the second position being rotated from the first position.

13. The engine of claim 12, wherein the first and second sides are defined on opposing sides of the cylinder head assembly.

14. The engine of claim 12, wherein the second position is rotated generally 180 degrees about the connecting surface of the engine block from the first position.

15. The engine of claim 12, wherein the one or more inlets and the one or more outlets are located in a cylinder head of the cylinder head assembly.

16. The engine of claim 15, wherein the cylinder head is covered by a valve cover.
